(19) United States
(12) Patent Application Publication
(10) Pub. No.: US 2023/0267591 A1
(43) Pub. Date: Aug. 24, 2023

(54) AERIAL VEHICLE AND METHOD OF FORMING THE SAME, METHOD OF DETERMINING DIMENSION OF OBJECT

(71) Applicant: Singapore University of Technology and Design, Singapore (SG)

(72) Inventors: Shaohui FOONG, Singapore (SG); Meng Da Denzel LEE, Singapore (SG); Shawndy Michael LEE, Singapore (SG)

(21) Appl. No.: 18/005,616

(22) PCT Filed: Jul. 6, 2021
(86) PCT No.: PCT/SG2021/050392

§ 371 Date: Jan. 16, 2023

(30) Foreign Application Priority Data
Jul. 15, 2020 (SG) 10202006745X

(51) Int. Cl. G06T 7/00; G06T 7/70; G06T 7/50; G06T 7/10; B64U 10/13

(52) U.S. Cl. CPC G06T 7/0004; G06T 7/70; G06T 7/50; G06T 7/10; B64U 10/13; G06T 2207/20084; B64U 2101/30

(57) ABSTRACT

Various embodiments may relate to an aerial vehicle. The aerial vehicle may include a frame. The aerial vehicle may also include a camera assembly attached to the frame, the camera assembly including a cascaded bi-directional linear actuator and a camera attached to the cascaded bi-directional linear actuator such that the camera is configured to be moved to different positions by the cascaded bi-directional linear actuator to capture a plurality of images of an object. The aerial vehicle may further include a processor in electrical connection to the camera such that the processor is configured to determine one or more dimensions of the object based on the plurality of images. The aerial vehicle may additionally include a flight system configured to move the aerial vehicle. The aerial vehicle may also include an energy system in electrical connection to the camera assembly, the processor, and the flight system.

### CROSS-REFERENCE TO RELATED APPLICATION

This is a national phase of PCT application PCT/SG2021/050392, filed on Jul. 6, 2021, which claims the benefit of priority of Singapore application No. 10202006745X filed Jul. 15, 2020, the contents of it being hereby incorporated by reference in its entirety for all purposes.

### TECHNICAL FIELD

Various embodiments of this disclosure may relate to an aerial vehicle. Various embodiments of this disclosure may relate to a method of forming an aerial vehicle. Various embodiments may relate to a method of determining one or more dimensions of an object.

### BACKGROUND

With the emergence of the drone industry, aerial robotics solutions have been expanding its utility capabilities and integrating into various sectors to replace conventional workflow to improve operational productivity. Some benefits of aerial robots include increasing the efficiency of labor-intensive operation, eliminating deployment of heavy machinery to access remote places, and enhancing safety in environments that pose high operational risks.

Visual inspection is an area where there is a widespread use of aerial robots. Applications can range from outdoor trees, outside surfaces of infrastructures to indoor confined spaces of underground mines, and inside of infrastructures. When coupled with computer vision algorithms, this can help to attain valuable insights on information such as conditions or measurements.

### SUMMARY

Various embodiments may relate to an aerial vehicle. The aerial vehicle may include a frame. The aerial vehicle may also include a camera assembly attached to the frame, the camera assembly including a cascaded bi-directional linear actuator and a camera attached to the cascaded bi-directional linear actuator such that the camera is configured to be moved to different positions by the cascaded bi-directional linear actuator to capture a plurality of images of an object. The aerial vehicle may further include a processor in electrical connection to the camera such that the processor is configured to determine one or more dimensions of the object based on the plurality of images. The aerial vehicle may additionally include a flight system configured to move the aerial vehicle. The aerial vehicle may also include an energy system in electrical connection to the camera assembly, the processor, and the flight system.

Various embodiments may relate to a method of forming an aerial vehicle. The method may include attaching a camera assembly to a frame, the camera assembly including a cascaded bi-directional linear actuator and a camera attached to the cascaded bi-directional linear actuator such that the camera is configured to be moved to different positions by the cascaded bi-directional linear actuator to capture a plurality of images of an object. The method may also include electrically connecting a processor to the camera such that the processor is configured to determine one or more dimensions of the object based on the plurality of images. The method may further include providing a flight system configured to move the aerial vehicle. The method may also include electrically connecting an energy system to the camera assembly, the processor, and the flight system.

Various embodiments may relate to a method of determining one or more dimensions of an object. The method may include moving an aerial vehicle towards the object using the using a flight system of the aerial vehicle. The aerial vehicle may also include a frame. The aerial vehicle may further include a camera assembly attached to the frame, the camera assembly include a cascaded bi-directional linear actuator and a camera attached to the cascaded bi-directional linear actuator. The aerial vehicle may additionally include a processor in electrical connection to the camera. The aerial vehicle may also include an energy system in electrical connection to the camera assembly, the processor, and the flight system. The method may also include moving the camera to different positions using the cascaded bi-directional linear actuator to capture a plurality of images of the object. The method may further include determining one or more dimensions of the object based on the plurality of images using the processor.

### BRIEF DESCRIPTION OF THE DRAWINGS

In the drawings, like reference characters generally refer to the same parts throughout the different views. The drawings are not necessarily drawn to scale, emphasis instead generally being placed upon illustrating the principles of various embodiments. In the following description, various embodiments of the invention are described with reference to the following drawings.

FIG. 1A shows a schematic of the portion of the railway including rail viaducts and the structural pier.

FIG. 1B shows a schematic of the rail viaduct cavity mockup that is of the same dimensions as the actual rail viaduct cavity.

FIG. 2 is a general illustration of an aerial vehicle according to various embodiments.

FIG. 3 is a general illustration of a method of forming an aerial vehicle according to various embodiments.

FIG. 4 is a general illustration of a method of determining one or more dimensions of an object.

FIG. 5 shows a pinhole camera model for the pseudo-stereo camera configuration capable of taking n-th stereoscopic image pair according to various embodiments.

FIG. 6A shows a first portion of a flow chart illustrating automated dimensional extraction algorithm from the calibration of the pseudo-stereo camera assembly according to various embodiments.

FIG. 6B shows a second portion of the flow chart illustrating automated dimensional extraction algorithm from the calibration of the pseudo-stereo camera assembly according to various embodiments.

FIG. 7A is a schematic showing the camera on the cascaded bi-directional linear actuator capable of changing its baseline bₙ dynamically and stopping at the Nₚₒₛ position according to various embodiments.

FIG. 7B shows the training data set including the original stitched image and different image augmentation that includes motion blurred, Gaussian blurred, darken and brighten, with the corresponding mask labels according to various embodiments.

FIG. 8 is a U-net training model graph of loss as a function of epoch number according to various embodiments.

FIG. 9 shows the disparity of left edges of reference region between Imageᵢ and Imageᵢ₊₁ according to various embodiments.

FIG. 10 is a schematic showing a pinhole camera model of the stitched image according to various embodiments.

FIG. 11A shows components of the pseudo-stereo camera assembly according to various embodiments.

FIG. 11B shows the components of the box-in frame design of the Bearing Inspector for Narrow-space Observation (BINO) vehicle according to various embodiments.

FIG. 11C shows the Bearing Inspector for Narrow-space Observation (BINO) vehicle with power tethering unit according to various embodiments.

FIG. 11D shows a side view of the Bearing Inspector for Narrow-space Observation (BINO) vehicle according to various embodiments.

FIG. 11E shows a top view of the Bearing Inspector for Narrow-space Observation (BINO) vehicle according to various embodiments.

FIG. 12 shows the depth calculation of using disparity values between generated masks from image pair according to various embodiments.

FIG. 13 shows (above) a depth map generated by a commercial depth camera (Intel Realsense 435i); and (below) a stitched image formed by the algorithm (depth 170 mm) according to various embodiments.

FIG. 14 is an image illustrating a power tethering unit coupled to the aerial vehicle (micro unmanned aerial vehicle or mUAV) according to various embodiments.

### DESCRIPTION

The following detailed description refers to the accompanying drawings that show, by way of illustration, specific details and embodiments in which the invention may be practised. These embodiments are described in sufficient detail to enable those skilled in the art to practise the invention. Other embodiments may be utilized and structural, logical, and electrical changes may be made without departing from the scope of the invention. The various embodiments are not necessarily mutually exclusive, as some embodiments can be combined with one or more other embodiments to form new embodiments.

Embodiments described in the context of one of the aerial vehicle or methods are analogously valid for the other aerial vehicles or methods. Similarly, embodiments described in the context of a method are analogously valid for an aerial vehicle, and vice versa.

Features that are described in the context of an embodiment may correspondingly be applicable to the same or similar features in the other embodiments. Features that are described in the context of an embodiment may correspondingly be applicable to the other embodiments, even if not explicitly described in these other embodiments. Furthermore, additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance.

As used herein, the term “and/or” includes any and all combinations of one or more of the associated listed items.

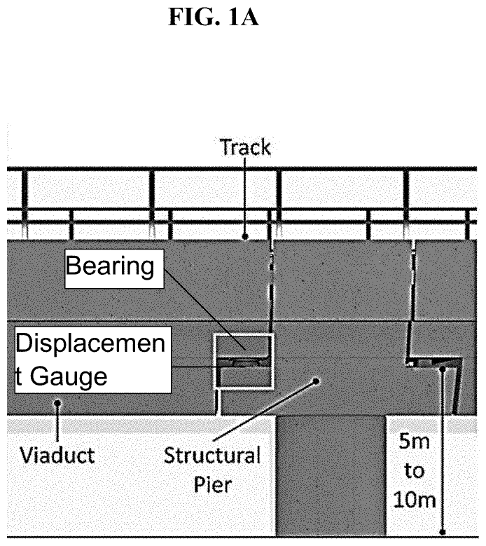

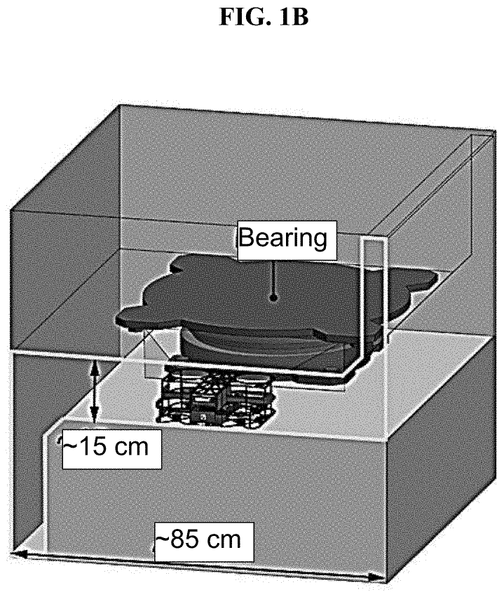

Various embodiments may relate to the inspection of the rail viaduct bearing. This bearing is inside of a cavity between the structural pier and the viaducts. It serves to structurally connect the pier and viaducts as they are separately constructed. FIG. 1A shows a schematic of the portion of the railway including rail viaducts and the structural pier. FIG. 1B shows a schematic of the rail viaduct cavity mockup that is of the same dimensions as the actual rail viaduct cavity.

Viaduct bearing inspection is an important task that needs to be conducted periodically. It may entail a visual inspection of the bearing and the examination of the displacement gauge integrated into the bearing system. As mentioned above, the bearing is elevated above ground and located in a cavity between the structural pier and the viaducts.

At a height range from 5 m to 10 m above ground, the methods available to access the bearings are troublesome and cumbersome. The current conventional method of inspection requires a civil engineer to examine the bearing visually from outside of the cavity. This process, which is conducted at a high height and which involves heavy machinery or construction of scaffolds, may be hugely time-consuming, expensive, inefficient, and/or inherently dangerous. For instance, the bearing can be visually inspected by employing specialized overhead-rig machines on the rail viaduct, using ground-based vehicular cranes/cherry pickers, or erecting scaffolding. All these methods are similar in the sense they provide a platform for personnel to gain access to the cavity. However, these methods may be inherently dangerous due to the risk of falling, and may require supporting crew to operate the machinery or construct the scaffolds. In addition to being costly, using overhead-rings that operate on the rail viaduct may not be efficient as it can only be done when the rail is not in operation. Vehicular cranes may require road access. As such, not all viaducts can be inspected this way. Scaffolding may be extremely time-consuming.

The accessibility constraints of the bearing make an aerial robot the optimal choice for its ability to directly access high and remote areas, ease of deployment, and retrieval. The airborne mode of locomotion also leads to lesser disturbance to the surrounding area and smaller operation space; reducing the disruption to the public or vehicular traffic flow. These benefits ultimately allow the expedition of the inspection process so that more bearing inspections can take place in the same period as compared to its conventional counterpart.

The current existing research for infrastructure inspection applications using aerial robotics make use of segmentation to extract regions of interests (e.g. Nguyen et al., “Mavnet: An effective semantic segmentation micro-network for may-based tasks,” IEEE Robotics and Automation Letters, vol. 4, pp. 3908-3915, October 2019; and Vetrivel et al., “Segmentation of uav-based images incorporating 3d point cloud information,” vol. XL-3/W2, 03 2015). However, they may not extend further into the analysis of these segmented areas. For the development of MavNet, they focus more on achieving real-time semantic segmentation prediction, instead of the accuracy of the prediction. Real-time capability is beneficial when the conditions of inspection target can be estimated while the aerial robotics operates without landing always. In their work, the proposed application was the detection of corrosion on a surface area, where the conditional preview of the surface is sufficient rather than precise of the corrosion side. Such an application would not require high accuracy from the model. The accuracy of the MavNet model is approximately 58% for corrosion detection. For Vetrivel et al., they presented point cloud based segmentation incorporating point cloud information. While it is an enviable approach to adopt for our application, working with point cloud data is computationally expensive. The computational load means that it is difficult for most existing companion computers to generate the three dimensional (3D) model efficiently. Even though working with point cloud or Light Detection and Ranging (LiDAR) data has been the popular method, it is not easy to generate a geo-spatial accurate 3D model. Even if the segmentation result is good, the geo-spatial accuracy needs to be established first to provide quality dimensions.

Various embodiments may relate to the development of automated dimensional extraction of the targeted regions using n-th stereoscopic images collected from the camera assembly. In essence, this algorithm, when coupled with the aerial platform (Bearing Inspector for Narrow-space Observation or BINO), may enable rapid and accurate inspection of the bearings. The algorithm as described herein may modernize current inspection methods by eliminating the need for manual intervention throughout the inspection process. The aerial platform may include a pseudo-stereo configured camera assembly, capable of taking images from different positions of the rack-and-pinion cascaded bi-directional linear actuator. The availability of stereo pairs may enable processes that include stitching, depth perception, and image segmentation. The combined end-to-end solution can enhance the quality, safety, and efficiency of the rail viaduct bearing inspection.

The BINO vehicle may be designed specifically to carry out the task of viaduct bearing inspections, located within a tight cavity space of a vertical pier supporting the overhead rail network structure in Singapore. Features on the BINO vehicle may be meant to resolve current operational constraints, enhance inspection quality, improve efficiency and adhere to operational safety requirements. Some of these features may include operating in confined space, ability to view the entire length of the bearing from a single camera system, measurement of key bearing dimension using deep learning, panoramic stitching and photogrammetry methods, the need for a tethered system for safety and enhancement of operating endurance.

Currently, there is no off-the-shelf drone solution that can fulfil all the requirements of inspecting the bearing. Commercial drones of similar size such as Mavic Pro, Mavic Air will not be suitable for this operation. These drones are designed for high altitude aerial videography or photography and are not designed to operate close to structural elements. Most of the components, which include propellers, motors and other hardware, on these commercial drones are not enclosed which meant it cannot safely operate within the cavity. These drones are not designed to be impact resilient and would usually crash when their exposed propulsion system comes into contact. The imaging systems of these commercial drones are optimized for outdoor and long-range image capture, and not suitable for capturing a bot bearing up and close in the low light condition present in the cavity. The degree of freedom for their camera system is often restricted to two (up and down), which limits the drone to capture the entire length of the bearing. Furthermore, post processing of the images captures is required and there is no known complete solution that can automatically extract the necessary dimensions off the bearing. A large majority of the commercial drones are relatively large and heavy, with the DJI Mavic Pro weighing in at 800 g.

The BINO vehicle according to various embodiments is a compact unmanned aerial vehicle (UAV), which may be designed to overcome the limitations mentioned above. The planned operation concept for the BINO vehicle is to fly into the cavity and land quickly onto an available spot for image capturing. The components of the BINO vehicle may be enclosed within its frame, ensuring safe operation within the cavity. One requirement may be that the BINO vehicle should not shift nor change its position frequently given the constraint space within the cavity. A cascaded bi-directional linear actuator may be built into the BINO to minimise the need for BINO to fly within the cavity to capture the images of the bearing. Once landed, the actuator may provide the ability for the onboard camera to shift from left to right to capture all the required images of the bearing without unnecessary movement of the BINO vehicle. These images may then be either stitched into a panoramic or be used to generate a three dimensional (3D) model, where key dimensional parameters can be extracted.

The vehicle may be tethered to a ground system that provides power and datalink. The algorithm deployed may enable the automation of generating either the panoramic image or the three (3D) model of the whole bearing using multiple images of the bearing captured by the vehicle. Accurate dimensional extraction algorithms may then be applied to the panoramic image or the 3D model. This approach removes the necessity of requiring humans to work at elevated heights during inspection.

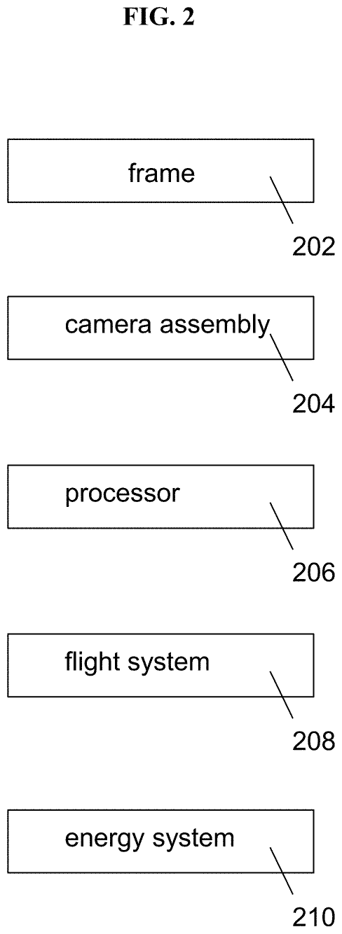

FIG. 2 is a general illustration of an aerial vehicle according to various embodiments. The aerial vehicle may include a frame 202, The aerial vehicle may also include a camera assembly 204 attached to the frame 202, the camera assembly 204 including a cascaded bi-directional linear actuator and a camera attached to the cascaded bi-directional linear actuator such that the camera is configured to be moved to different positions by the cascaded bi-directional linear actuator to capture a plurality of images of an object. The aerial vehicle may further include a processor 206 in electrical connection to the camera such that the processor is configured to determine one or more dimensions of the object based on the plurality of images. The aerial vehicle may additionally include a flight system 208 configured to move the aerial vehicle. The aerial vehicle may also include an energy system 210 in electrical connection to the camera assembly 204, the processor 206, and the flight system 208.

For avoidance of doubt, FIG. 2 serves to illustrate the features of the aerial vehicle according to some embodiments, and is not intended to limit the arrangement, shape, size, orientation etc. of the various features.

In various embodiments, the aerial vehicle may be an unmanned aerial vehicle (UAV), such as a micro-class UAV. The aerial vehicle may be a Bearing Inspector for Narrow-space Observation (BINO) vehicle.

In various embodiments, the camera may be a single monocular camera. The camera attached to the cascaded bi-directional linear actuator may mimic the characteristics of a parallel stereo camera. The camera may allow for on board high definition (HD) and live transmission with camera optics designed for close up inspection. The cascaded bi-directional linear actuator may be an actuator that includes multiple tiered rack and pinion components stacked on top of one another, and is configured to move along a straight line in a first direction, or a second direction opposite the first direction.

In various embodiments, the processor 206 may be configured to determine a depth (D_{w}) between the camera and a reference region of the object.

In various embodiments, the processor 206 may be further configured to determine a distance (bₙ) between adjacent positions of the camera to capture successive images of the plurality of images based on the depth (D_{w}) between the camera and a reference region of the object, and a desired overlap percentage between the successive images (O_{desired}). The distance (bₙ) may also be further based on a camera sensor width (s_{w}) of the camera and the focal length (f) of the camera.

A horizontal camera field of view (W_{w}) may be based on the depth (D_{w}) between the camera and a reference region of the object, the camera sensor width (s_{w}) and the focal length (f). The number of stops the camera may make along the cascaded bi-directional linear actuator (└Nₚₒₛ┘) may be based on a maximum travel length (Lₘₐₓ) of the cascaded bi-directional linear actuator, the horizontal camera field of view, and the distance (bₙ). A maximum horizontal field of view (Wₘₐₓ) may be a sum of the maximum travel length (Lₘₐₓ) and the horizontal camera field of view (W_{w}).

In various embodiments, the processor 206 may be configured to stitch the plurality of images to form a stitched image.

In various embodiments, the processor 206 may be configured to make a stitched image prediction based on the stitched image using an image semantic segmentation neural network. In other words, the processor 206 may be configured to determine one or more targeted regions in the stitched image using an image semantic segmentation neural network. The image semantic segmentation neural network may be a convolutional network such as U-Net.

In various embodiments, the processor 206 may be configured to make single image predictions using the image semantic segmentation neural network. In other words, the one or more targeted regions may be determined based on the images of the plurality of images based on the convolutional network, e.g. U-Net. In various embodiments, the processor 206 may be configured to determine a depth (e.g. D₁, D₂) between the camera and each targeted region of the one or more targeted regions based on images of the plurality of images capturing the one or more targeted regions.

In various embodiments, the one or more dimensions of the object (e.g. X₁, X₂, A₁, A₂) may be determined from the stitched image. The processor 206 may be configured to determine one or more dimensions of the object in the stitched image (x₁, x₂). The processor 206 may be also configured to determine one or more dimensions of the reference region in the stitched image (e.g. x_{ref}, y_{ref}). In various embodiments, the one or more dimensions of the object (e.g. X₁, X₂, A₁, A₂) may be determined based on the depth (e.g. D₁, D₂) between the camera and each targeted region of the one or more targeted regions, the one or more dimensions of the object in the stitched image (x₁, x₂), and the one or more dimensions of the reference region in the stitched image (e.g. x_{ref}, y_{ref}). The one or more dimensions of the object (e.g. X₁, X₂, A₁, A₂) may additionally be based on the one or more dimensions of the reference region in the object (X_{ref}, Y_{ref}), which may be known, and the depth between the camera and the reference region (D_{ref}=D_{w}).

In other words, the one or more dimensions of the object (e.g. X₁, X₂, A₁, A₂) may be determined based on the depth (e.g. D₁, D₂) between the camera and each targeted region of the one or more targeted regions obtained from single image predictions. The one or more dimensions of the object (e.g. X₁, X₂, A₁, A₂) may also be determined based on the depth between the camera and the reference region (D_{ref}=D_{w}) during the calibration process. The processor 206 may be configured to determine or measure one or more dimensions of the object in the stitched image (x₁, x₂) and one or more dimensions of the reference region in the stitched image (e.g. x_{ref}, y_{ref}). The one or more dimensions of the object (e.g. X₁, X₂, A₁, A₂) may be determined may be also based on the one or more dimensions of the object in the stitched image (x₁, x₂), the one or more dimensions of the reference region in the stitched image (e.g. x_{ref}, y_{ref}), and one or more dimensions of the reference region in the object (X_{ref}, Y_{ref}), which may be known. The reference region of the object may be chosen because its dimensions will not or are unlikely to change over time.

In various embodiments, the flight system 208 may include a propulsion system configured to propel the aerial vehicle, and a flight controller configured to control the propulsion system to move (i.e. the aerial vehicle) in a desired direction. The propulsion system may include one or more propellers.

In various embodiments, the aerial vehicle may also include an illumination system configured to provide illumination to the object. The illumination system may include one or more light emitting diode (LED) chips. The illumination system may allow for operation in low light condition.

In various embodiments, the energy system 210 may include a power system configured to be electrically coupled to a power tethering unit. The power system may include a direct current—direct current (DC-DC) voltage converter.

The power tethering unit may be a smart tether system. The power tethering unit may include an automated tether anchor and a tether line having a first end physically coupled to the automated tether anchor, and a second end physically coupled to the frame 202 of the aerial vehicle. The smart tether system may ensure safe operation of the aerial vehicle by physically limiting the flight altitude of the aerial vehicle so the aerial vehicle would not interfere with above viaduct rail operations. The smart tether system may also provide an anchor so that the aerial vehicle is easier to operate. The smart tether system may additionally establish a power link with the aerial vehicle so that the aerial vehicle can be operated for an extended period of time. The smart tether system may be automated such that the tether line is always taut during operation. In various embodiments, the aerial vehicle may include the power tethering unit.

In various embodiments, the cascaded bi-directional linear actuator may include a motor. The cascaded bi-directional linear actuator may further include a rack-and-pinion system configured to move the camera linearly based on a rotational motion of the motor. The rack-and-pinion system may include a gear rack and a circular gear configured to cooperate with the gear rack to transform or convert a rotational motion of the motor into a linear motion of the camera.

The frame 202 may include two parts, which may enclose the other components such as the camera assembly 204, the processor 206, the flight system 208, and/or the energy system 210. Various embodiments may be impact resilient. The frame may provide a fully cowled aerodynamic structural design which protects the propulsion system from all sides and reduce susceptibility to wind.

Various embodiments may enable safer working environment for workers. Various embodiments may allow for the inspection of bearing without need for deployment of heavy machinery and cumbersome scaffolding. Various embodiments may allow for automatic and algorithmic measurements of key bearing dimension, eliminating the need for manual process, and enhancing inspection quality. Various embodiments may relate to a customisable platform catering to different requirements. The power tethering unit may provide extended flight time as well as improvement of safety for aerial vehicle operation.

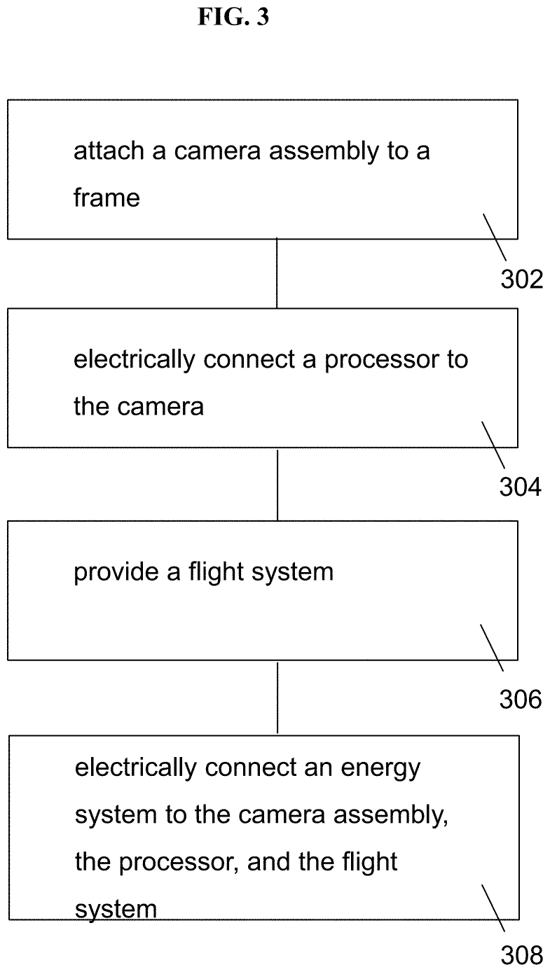

FIG. 3 is a general illustration of a method of forming an aerial vehicle according to various embodiments. The method may include, in 302, attaching a camera assembly to a frame, the camera assembly including a cascaded bi-directional linear actuator and a camera attached to the cascaded bi-directional linear actuator such that the camera is configured to be moved to different positions by the cascaded bi-directional linear actuator to capture a plurality of images of an object. The method may also include, in 304, electrically connecting a processor to the camera such that the processor is configured to determine one or more dimensions of the object based on the plurality of images. The method may further include, in 306, providing a flight system configured to move the aerial vehicle. The method may also include, in 308, electrically connecting an energy system to the camera assembly, the processor, and the flight system.

For avoidance of doubt, FIG. 3 is not intended to be in sequence. For instance, step 302 can occur before, after, or at the same time as step 304.

In various embodiments, the processor may be configured to determine a depth between the camera and a reference region of the object.

In various embodiments, the processor may be further configured to determine a distance between adjacent positions of the camera to capture successive images of the plurality of images based on the depth between the camera and a reference region of the object, and a desired overlap percentage between the successive images. The distance may also be further based on a camera sensor width of the camera and the focal length of the camera.

In various embodiments, the processor may be configured to stitch the plurality of images to form a stitched image.

In various embodiments, the processor may be configured to determine one or more targeted regions in the stitched image using an image semantic segmentation neural network.

In various embodiments, the processor may be configured to determine a depth between the camera and each targeted region of the one or more targeted regions based on images of the plurality of images capturing the one or more targeted regions.

In various embodiments, the one or more dimensions of the object may be determined from the stitched image. The processor may be configured to determine one or more dimensions of the object in the stitched image. The processor may be also configured to determine one or more dimensions of the reference region in the stitched image. In various embodiments, the one or more dimensions of the object may be determined based on the depth between the camera and each targeted region of the one or more targeted regions, the one or more dimensions of the object in the stitched image, and the one or more dimensions of the reference region in the stitched image. The one or more dimensions of the object may additionally be based on the one or more dimensions of the reference region in the object, which may be known, and the depth between the camera and the reference region.

In various embodiments, the flight system may include a propulsion system configured to propel the aerial vehicle, and a flight controller configured to control the propulsion system to move in a desired direction.

In various embodiments, the method may also include providing an illumination system to provide illumination to the object.

In various embodiments, the energy system may include a power system configured to be electrically coupled to a power tethering unit. In various embodiments, the energy system may also include the power tether unit.

In various embodiments, the cascaded bi-directional linear actuator may include a motor. The cascaded bi-directional linear actuator may also include a rack-and-pinion system configured to move the camera linearly based on a rotational motion of the motor.

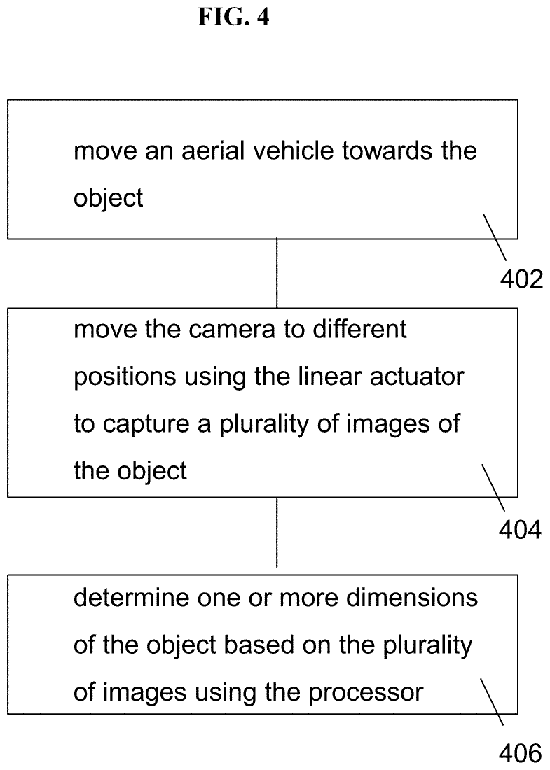

FIG. 4 is a general illustration of a method of determining one or more dimensions of an object. The method may include, in 402, moving an aerial vehicle towards the object using the using a flight system of the aerial vehicle. The aerial vehicle may also include a frame. The aerial vehicle may further include a camera assembly attached to the frame, the camera assembly include a cascaded bi-directional linear actuator and a camera attached to the cascaded bi-directional linear actuator. The aerial vehicle may additionally include a processor in electrical connection to the camera. The aerial vehicle may also include an energy system in electrical connection to the camera assembly, the processor, and the flight system. The method may also include, in 404, moving the camera to different positions using the cascaded bi-directional linear actuator to capture a plurality of images of the object. The method may further include, in 406, determining one or more dimensions of the object based on the plurality of images using the processor.

In various embodiments, the object may be a rail viaduct bearing. The rail viaduct bearing may be within a cavity formed by a rail viaduct and a structural pier. Moving an aerial vehicle towards the object may include moving the aerial vehicle into the cavity formed by the rail viaduct and the structural pier.

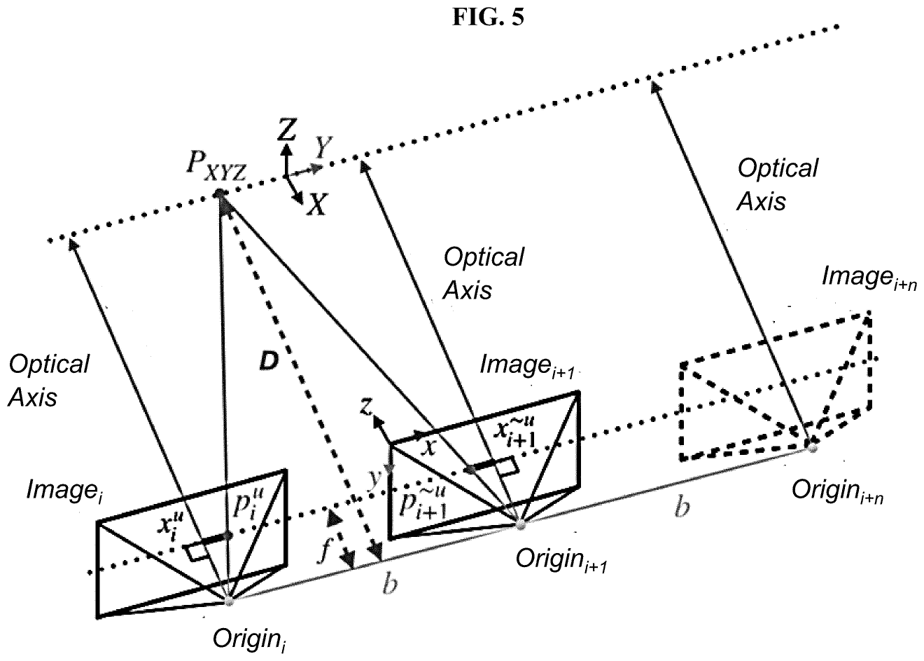

In various embodiments, the camera assembly may include a camera on a rack-and-pinion cascaded bi-directional linear actuator configuration. The reason for this set up is to mimic the characteristic of a parallel stereo camera. The definition of stereo camera in a parallel set up may refer to having two cameras with both parallel optical axis. FIG. 5 shows a pinhole camera model for the pseudo-stereo camera configuration capable of taking n-th stereoscopic image pair according to various embodiments. A general stereo camera may need both the translational and the rotational position matrices between the cameras as the baseline, where b=[R|t]. In the case of the parallel stereo camera, the baseline only consists of the translational matrix in the x-axis, b=t, where t=[Tₓ, 0,0]. The reduction of the matrices may allow for the baseline to be more accurately calculated. Since every corresponding point on the adjacent images, pᵢ^{u,v} and [symbol] , lies on the same projective horizontal line, the y-axis of each point on both images, can be ignored, further simplifying the derivation of depth.

pᵢ^{v}∈Imageᵢ= [symbol] ∈Imageᵢ₊₁ (1)

Another common characteristic of a typical stereo camera is the simultaneous capture of both image pairs. However, the targeted bearing scene within the cavity is static, and hence, it eliminates the demand for simultaneous behaviour.

The purpose of the camera calibration process is to resolve camera parameters that correspond from the pixel coordinates, p[_{u,v,1}], to an object in the world coordinate frame, P_{XYZ}. For the calibration process, the calibration algorithm from the Open Computer Vision Library (OpenCV) may be used. The process may involve collecting an image set that consists of at least ten good images of asymmetrical circle pattern and running the algorithm with the images as input. This calibration process may eventually resolve to a camera matrix that contains the intrinsic parameters, among other derived information. Within the camera matrix, the focal length in the X-axis expressed in pixel coordinates, λₓ, may be of the highest interest.

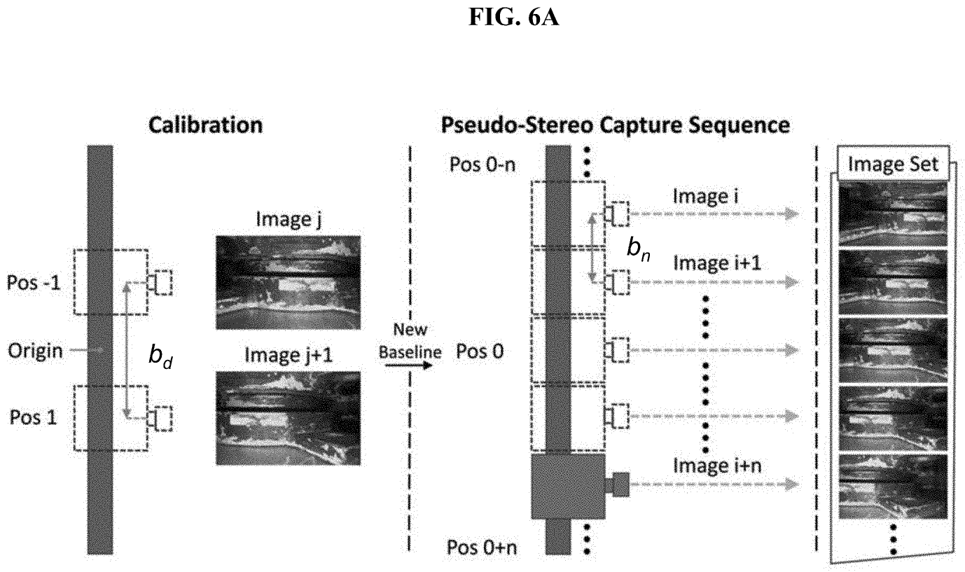

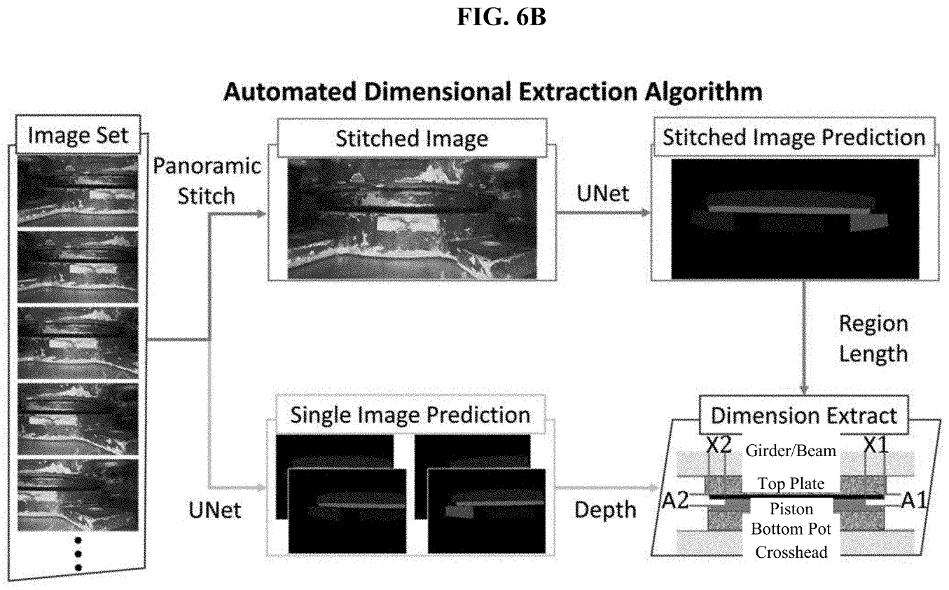

FIG. 6A shows a first portion of a flow chart illustrating automated dimensional extraction algorithm from the calibration of the pseudo-stereo camera assembly according to various embodiments. FIG. 6B shows a second portion of the flow chart illustrating automated dimensional extraction algorithm from the calibration of the pseudo-stereo camera assembly according to various embodiments.

As shown in FIGS. 6A-B, the operation of the camera assembly may begin after BINO has successfully landed within the cavity. It may start with the calibration sequence of collecting a pair of images to form a stereo pair with the default baseline, b_{d}, setting. The camera on the actuator begins from its origin position and moves to position −1, capturing Imageⱼ and next moves to position 1, capturing the Imageⱼ₊₁ (see FIG. 6A under calibration)

From this stereoscopic image set, the depth, D_{w} from the camera to a reference object or region (see FIG. 6A) may be calculated. For the optimal panoramic stitching result, the algorithm upholds the recommendation of a 70% overlap between images. The default baseline, b_{d}, of the stereoscopic camera operation dynamically changes to a new baseline, bₙ, which is implemented to achieve the desired overlap percentage, O_{desired}.

The different regions of a rail viaduct bearing may be of different depths. The final output measurements derived from the pinhole camera model may take into account the depth of these different regions of the bearing. Therefore, in order for the proposed algorithm to produce quality measurement results of the different targeted bearing areas, it may be essential to have accurate depth perception information.

Depth, D_{w}, between the camera origin, and the world frame, P_{XYZ} may be derived from a pinhole stereo camera model (see FIG. 5) with the first set of stereoscopic image using,

$${D}_{w} = \frac{{b}_{d , n} \times {λ}_{x}}{{x}_{i}^{u} - {x}_{i + 1}^{\sim u}} \qquad ( 2 )$$

where b_{d,n} is either the default or calculated baseline, is the distance between the camera lens of the two images capture from an adjacent position on the cascaded bi-directional linear actuator. The variable λₓ is the focal length of the camera in the pixel coordinates derived from the camera calibration process. Lastly, xᵢ^{u}− [symbol] disparity may represent the shift in horizontal coordinates of two corresponding points in Imageⱼ and Imageⱼ₊₁ that form the stereo pair.

$${W}_{w} = \frac{{D}_{w} \times {s}_{w}}{f} \qquad ( 3 )$$

$${b}_{n} = {W}_{w} \times ( 1 - {O}_{desired} ) \qquad ( 4 )$$

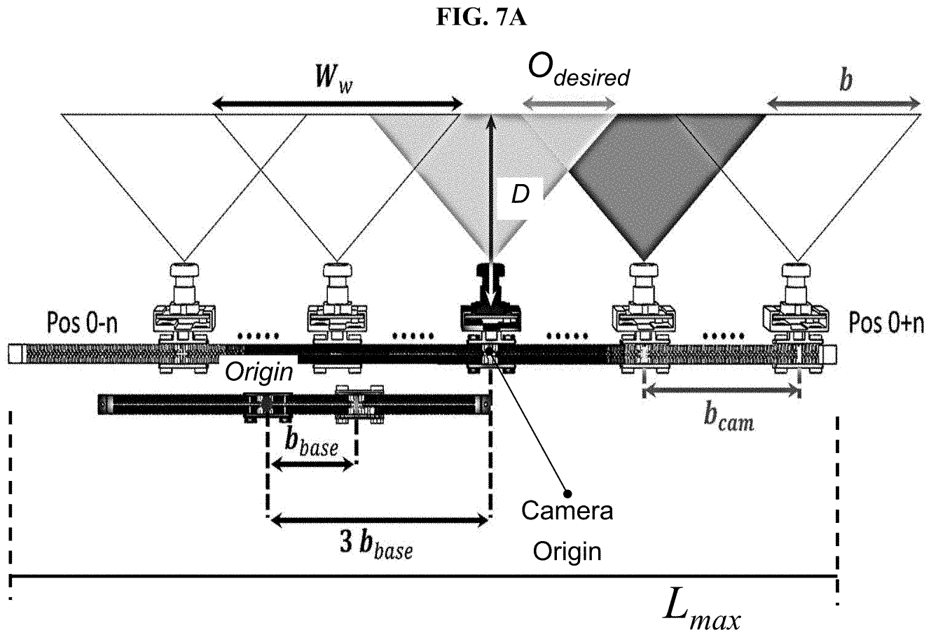

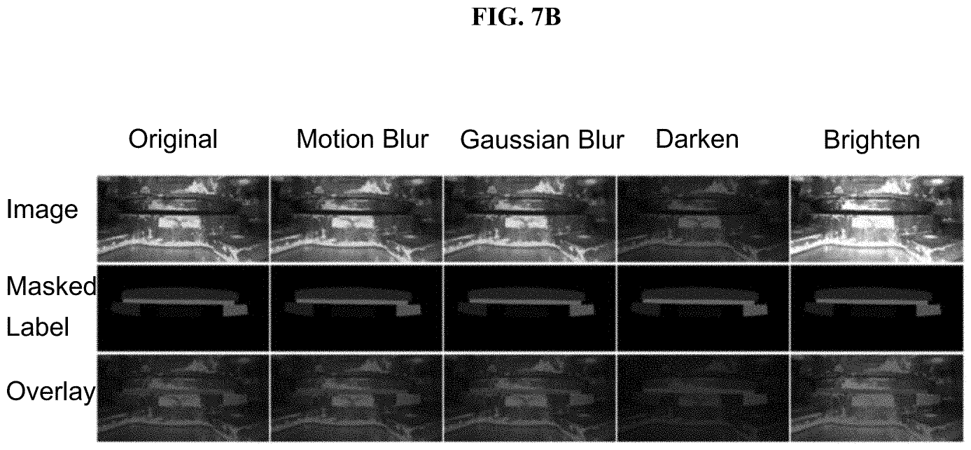

The depth, D_{w}, together with the camera sensor width, s_{w}, and the focal length in millimetre, f, may determine the horizontal camera field of view, W_{w}. The required new baseline, bₙ, to achieve the desired overlap of each image may then be the same as the percentage of the shift of each image captured, without overlapping with the previous, 1−O_{desired}, of the horizontal camera field of view, W_{w} (see FIG. 7A).

FIG. 7A is a schematic showing the camera on the cascaded bi-directional linear actuator capable of changing its baseline bₙ dynamically and stopping at the Nₚₒₛ position according to various embodiments.

The new baseline bₙ may ensure that there is a desired overlap between image pair to the n-th position on the actuator. However, the cascaded bi-directional linear actuator may realistically have a limited maximum travel length, Lₘₐₓ. Therefore, the number of positions that the camera needs to stop on the cascaded bi-directional linear actuator may be given as

$$⌊ {N}_{p o s} ⌋ = \frac{{L}_{max} - {W}_{w}}{{b}_{n}} \qquad ( 5 )$$

where └Nₚₒₛ┘ is the number of positions that the camera needs to stop on the cascaded bi-directional linear actuator. The floor function of the N positions is because the camera cannot travel further than the maximum length of the actuator. After the processor or companion computer dynamically calculates the new settings required, bi, and └Nₚₒₛ┘, the sequence to collect multiple stereo pairs covering the entire length of our inspection target may begin. The maximum horizontal field of view of the pseudo-stereo camera configuration is, therefore,

Wₘₐₓ=Lₘₐₓ+W_{w} (6)

The algorithm used may include four components: Panoramic Stitching, Image Segmentation, Depth Perception, and Dimension Extraction. The algorithm may be applied to image and to determine the dimensions of an actual decommission bearing housed in the mock-up cavity shown in FIG. 1B.

The purpose of image stitching is to increase the field of view of the camera by combining several views of the same space into a single image. This combined scene can present full information on the entire area, which in our application is the entire length of the bearing. The algorithm may adopt the method proposed by M. Brown and D. G. Lowe (“Automatic panoramic image stitching using invariant features,” International Journal of Computer Vision, vol. 74, no. 1, pp. 59-73, 2007), but some simplification may be made for this specific purpose. The first step is to extract 128-Dimension features using the Scale Invariant Feature Transform (SIFT) algorithm (D. G. Lowe, “Distinctive image features from scale-invariant keypoints,” Int. J. Comput. Vision, vol. 60, p. 91-110, November 2004) and matched between all images in an image set collected by the camera assembly sequence. Next, the random sample consensus (RANSAC) (M. A. Fischler and R. C. Bolles, “Random sample consensus: A paradigm for model fitting with applications to image analysis and automated cartography,” Commun. ACM, vol. 24, p. 381-395, June 1981), an iterative estimation method, may estimate the image transformation parameters from a random sample correspondence set of points. It may derive for the consensus set where it contains inliers. The description of inliers may be the projections of the points that are consistent with homography H_{i;i+1} within a tolerance E pixels.

The camera assembly may restrict the translation movement of the camera only along the X-axis, which allows the modelling of the overall camera system as a pinhole stereo camera model. Since the camera is not able to rotate on any of its [X, Y, Z] axes, the rotation matrix of the camera reduces to an identity matrix. The simplification of the rotation matrix further simplifies the pairwise homography \tilde{p}ᵢ=H_{i,i+1}\tilde{p}ᵢ₊₁, where H_{i,i+1}=KᵢRᵢRᵢ₊₁Kᵢ₊₁⁻¹, and \tilde{p}ᵢ, \tilde{p}ᵢ₊₁ are the homogenous image points.

$${K}_{i , i + 1} = [ \begin{matrix}{λ}_{i , i + 1} & 0 & 0 \\ 0 & {λ}_{i , i + 1} & 0 \\ 0 & 0 & 1\end{matrix} ] , {R}_{i , i + 1} = [ \begin{matrix}1 & 0 & 0 \\ 0 & 1 & 0 \\ 0 & 0 & 1\end{matrix} ] \qquad ( 7 )$$

The employment of Bundle adjustment (BA) (Triggs et al., “Bundle adjustment—a modern synthesis,” in Vision Algorithms: Theory and Practice, pp. 298-372, Springer Berlin Heidelberg, 2000) may be to refine the camera's intrinsic and extrinsic parameters concurrently, according to an objective function of reprojection errors. The optimization process of BA is the iterative sequence of minimizing the objection function, e, by predicting the position of observed points in an image set, which is the sum of squares of a large number of nonlinear functions.

e=Σᵢ₌₁ⁿΣ_{i+1∈I(i)}Σ_{k∈F(i,j)}|/pᵢ^{k}−proj_{i,i+1}^{k}|² (8)

where n is the number of images, I(i) is the subset of images matched to image i, F(i, i+1) is the corresponding features matches in images i, and i+1, proj_{i,i+1}^{k} is the projection of the k-th feature point, pᵢ^{k}, corresponding from image i+1 to image i.

The derivation of the nonlinear problem may be done using the Levenberg-Marquardt algorithm (J. J. Mor'e, “The levenberg-marquardt algorithm: Implementation and theory,” in Lecture Notes in Mathematics, pp. 105-116, Springer Berlin Heidelberg, 1978), which updates the camera parameters. Lastly, the overlapping area of the different images may be blended using gain compensation and multi-band linear blending algorithm (M. Brown and D. G. Lowe, “Automatic panoramic image stitching using invariant features,” International Journal of Computer Vision, vol. 74, no. 1, pp. 59-73, 2007; and M. Brown and D. G. Lowe, “Recognising panoramas,” in Proceedings of the Ninth IEEE International Conference on Computer Vision—Volume 2, ICCV '03, (USA), p. 1218, IEEE Computer Society, 2003).

Implementing an image semantic segmentation neural network may enable the proposed algorithm as described herein to identify and extract all targeted regions for measurement automatically. The neural network architecture chosen may be U-Net, a convolutional network (O. Ronneberger, P. Fischer, and T. Brox, “U-net: Convolutional networks for biomedical image segmentation,” 2015; and K. He, G. Gkioxari, P. Doll′ar, and R. Girshick, “Mask r-cnn,” 2017). There is plenty of image segmentation neural network architectures out in the research community. However, many of these are large and deep neural networks that require massive graphics processing unit (GPU) computational resource in order to attain good results.

The original application of U-Net is in the biomedical field. Since then, its application has expanded into various fields for the same purpose of image segmentation. The architecture may couple location knowledge, from the encoder path, with contextual knowledge, from the decoder path, to obtain prediction that contains both localization and context. Between the two paths, there may be skip connections (concatenation operator) that provide local information to the global information while decoding. Furthermore, it may not have any dense layer, which means that different image sizes can be input into the neural network. Lastly, U-Net may only require a small labelled data set for training. For instance, the authors of U-Net only used 30 public images as training data for their experiment.

The loss function applied for the U-Net model according to various embodiments may differ from the original. The challenge of the original loss function is that a small volume region hardly affects the loss, making it harder for accurate prediction of such region. A hybrid loss function that includes the dice loss and focal loss can address the issue. The dice loss may learn the class distribution mitigating the imbalanced data region problem, and the focal loss may ensure the model learn poorly classified pixels better. The loss function may be given as,

$${L}_{total} = {L}_{d i c e} + {L}_{focal} \qquad ( 9 )$$

$${L}_{total} = C - {\sum }_{c = 0}^{C - 1} \frac{T {P}_{p} ( c )}{T {P}_{p} ( c ) + α {FN}_{p} ( c ) + β {FP}_{p} ( c )} \qquad ( 10 )$$

where C is the total number of class including background, TPₚ(c) are true positives, FNₚ(c) are false negatives, FPₚ(c) are false positive, for class c prediction, while a and are the weights of penalties for FNₚ(c) and FPₚ (c) respectively.

The data used for the training of the U-Net model may consist of 550 stitched bearing images. FIG. 7B shows the training data set including the original stitched image and different image augmentation that includes motion blurred, Gaussian blurred, darken and brighten, with the corresponding mask labels according to various embodiments. The collection of images may involve various configurations, such as different depth, lighting, and positions, to ensure the model do not over-fit to a specific image condition. Twenty percent of the image set may be split up into a validation set at random. Among the remaining 440 training images, augmentation of the images was done at random. One augmentation sequence consists of motion blur at 100° and 280°, Gaussian blur, darkening, and brightening of the image. The number of images in the training set totaled out at 1100 images.

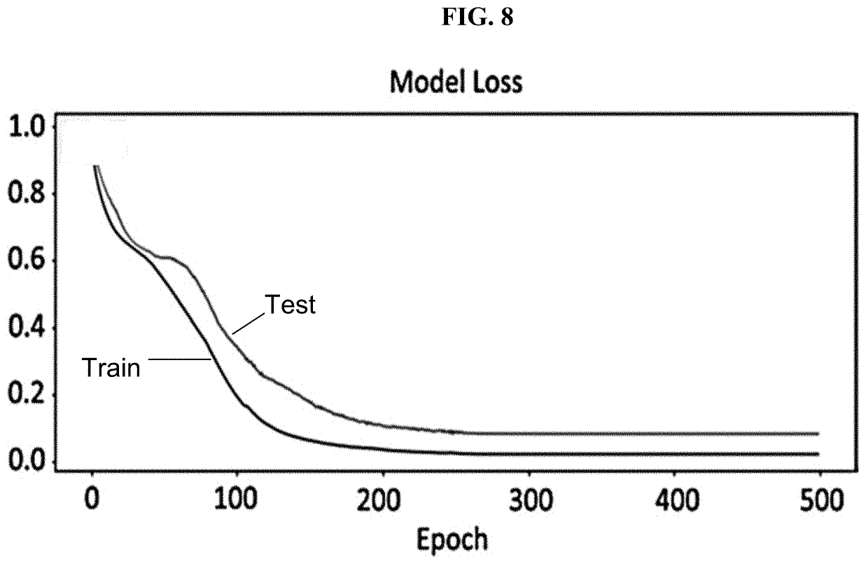

FIG. 8 is a U-net training model graph of loss as a function of epoch number according to various embodiments. The U-Net model manages to converge at approximate epochs number 280. The metrics for evaluating accuracy the model are the Intersection of Union (IOU) Score and the Dice Coefficient (F1 Score).

Table I shows the U-Net Model Training Parameters.

TABLE 1

| | | | Logistic | |
|---|---|---|---|---|
| Backbone | Activation | Batch size | Regression (LR) | Epochs |
| Resnet 34 | softmax | 20 | 0.0001 | 500 |

Table II shows the U-Net Model Training Results.

TABLE II

| | | Intersection over | Dice Coefficient |
|---|---|---|---|
| | Loss | Union (IOU) score | (F1 score) |
| Training Set | 0.0204 | 0.995 | 0.997 |
| Validation Set | 0.0798 | 0.905 | 0.949 |

Depth from the camera origin to an object may be derived from knowing the disparity of the corresponding region, focal length, and baseline with the two camera positions (see Equation 2). In order to retrieve consistent disparity values algorithmically, the shift of the object may be analysed using its segmentation encoded colour, as shown in Table III.

Table III shows the red-green-blue (RGB) values of segmented regions.

TABLE III

| | Ref Plate | Top Plate | Mid Plate |
|---|---|---|---|
| RGB | [0, 0, 128] | [128, 0, 128] | [128, 128, 0] |
| | Bottom Left Plate | Bottom Right Plate | |
| | [128, 0, 0] | [0, 128, 0] | |

The image set (before stitching) may be segmented with the same U-Net model. Shift between image pairs 1-2 and 4-5 may derive the disparity values of the left and right of the segmented region, respectively.

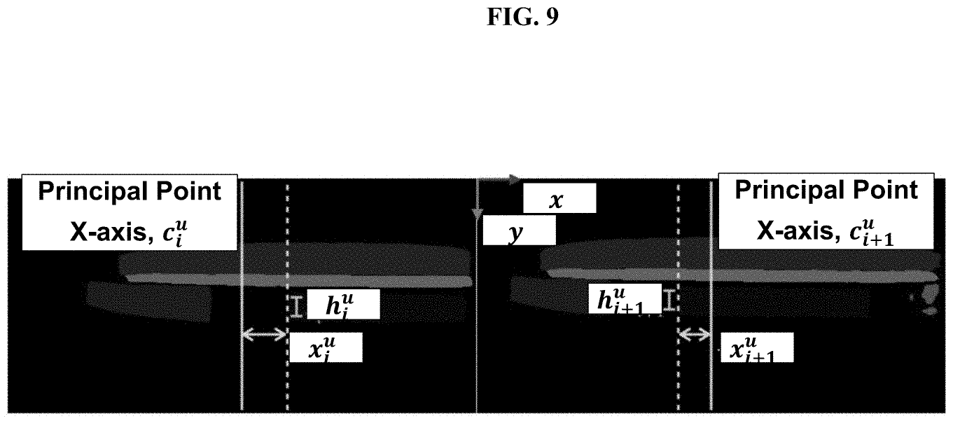

After extracting all targeted x-axis pixel coordinates on both images of the pair using the red-blue-green (RGB) values of the targeted region, any false positive prediction outliers may be removed by eliminating pixel coordinates that do not fall within the 68% confidence interval of the mean. The remaining collection of the x-axis pixel coordinate, hᵢ^{u} and hᵢ₊₁^{u}, may present the left vertical edge of the region in both image (see FIG. 9, disparity calculation for the reference region). FIG. 9 shows the disparity of left edges of reference region between Imageᵢ and Imageᵢ₊₁ according to various embodiments.

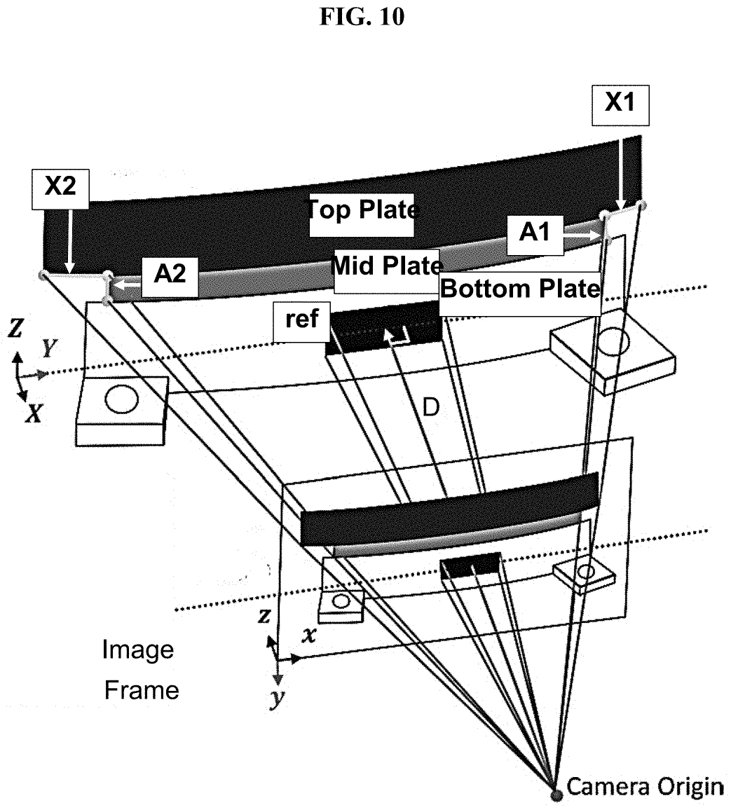

The dimensions critical for the inspection process may be X₁ and X₂ to observe the translational movement, and A₁ and A₂ to observe the rotational movement between the top and bottom plate of the rail viaduct bearing, as shown in FIG. 10. FIG. 10 is a schematic showing a pinhole camera model of the stitched image according to various embodiments. The dimension of the reference object, X_{ref} and Y_{ref}, may be given in the schematic of the bearing by the manufacturer. The criteria for choosing the reference region may be that it must be a fixed object that does not change its dimension over time. Excellent choices as the reference may be the base of the bearing or the scale bar built-in. The readings on the scale bar may often fade away over time rendering it useless for the current inspection process, but the algorithm as described herein may not be dependent on it.

The derivation of the following equations may be based on a pinhole camera model for the stitched bearing image. Similar triangles may determine the relationship between the length of all the segmented regions of the image and the world frame. With focal length, λₓ and λ_{y}, as the common variable, a combination of the similar triangle equations of the reference region and the targeted region may calculate the required length of X₁, X₂, A₁, and A₂. Even though X₁, A₁, X₂ and A₂ can be obtained from Equations 12 and 13 directly without the need for any reference object, but because of the image being stitched, the focal length of the stitch pinhole camera model may not be well-defined which results in inaccurate measurements. Therefore, a reference object may still be required to produce accurate measurements (see Equation 14).

$$\frac{{x}_{1 , 2}}{{λ}_{x}} = \frac{{X}_{1 , 2}}{{D}_{1 , 2}} and \frac{{x}_{r e f}}{{λ}_{x}} = \frac{{X}_{r e f}}{{D}_{r e f}} \qquad ( 12 )$$

$$\frac{{α}_{1 , 2}}{{λ}_{y}} = \frac{{A}_{1 , 2}}{{D}_{1 , 2}} and \frac{{y}_{r e f}}{{λ}_{y}} = \frac{{Y}_{ref}}{{D}_{ref}} \qquad ( 13 )$$

$${X}_{1 , 2} = \frac{{x}_{1 , 2} {D}_{1 , 2} {X}_{r e f}}{{x}_{ref} {D}_{ref}} and {A}_{1 , 2} = \frac{{α}_{1 , 2} {D}_{1 , 2} {Y}_{ref}}{{y}_{ref} {D}_{r e f}} \qquad ( 14 )$$

where x_{1,2}, α_{1,2} are the dimensions of the targeted region in pixel units, and x_{ref}, y_{ref} are the dimensions of the reference region in pixel units. D_{1,2} which represents the depth between the camera and the targeted region, and D_{ref}, which represents the depth between the camera and the reference region, may be calculated using Equation 2. Lastly, the focal length in pixel coordinates, λₓ and λ_{y}, may be obtained from the calibration process of the camera.

In the camera assembly setup, the camera used may be the IMX185 with an M12 lens by Leopard Imaging. The camera assembly on BINO may feature a maximum available cascaded bi-directional linear actuator length, Lₘₐₓ, of 510 mm. The Lₘₐₓ may translate to a maximum horizontal camera field of view Wₘₐₓ of 694 mm. Table IV shows the parameters of the IMX185 camera with the M12 lens parameters.

TABLE IV

| Sensor | | | Lens |
|---|---|---|---|
| Format | Width (s_{w}) | Height (sₕ) | Focal length (f) |
| 1/9″ | 6.74 mm | 5.05 mm | 5.5 mm |

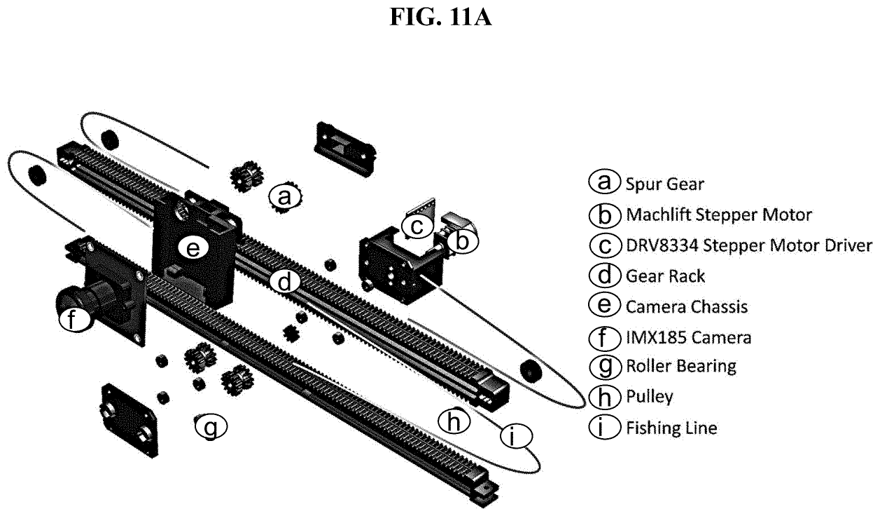

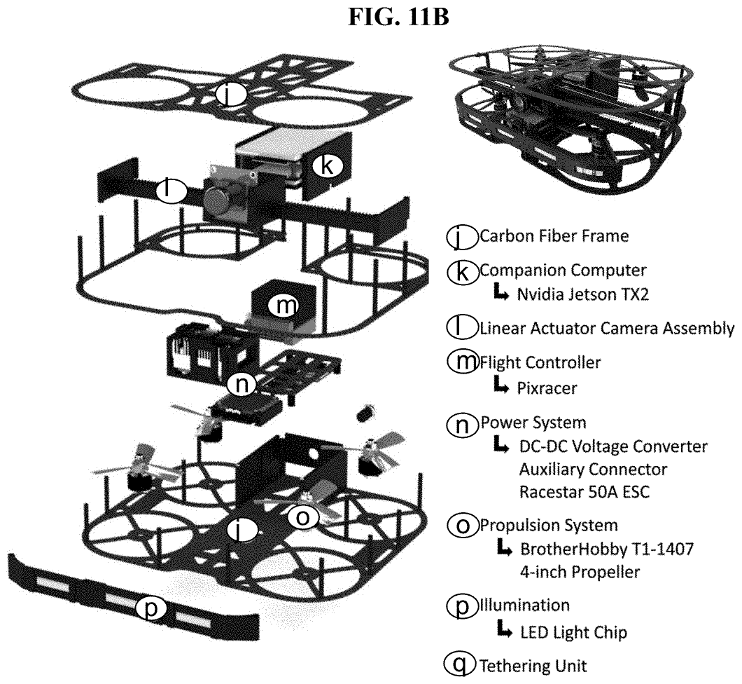

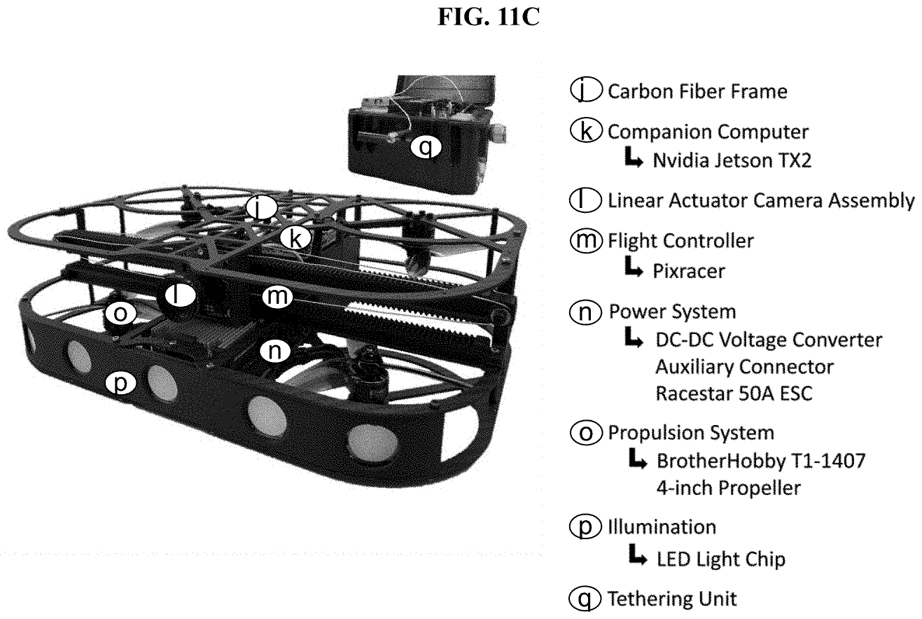

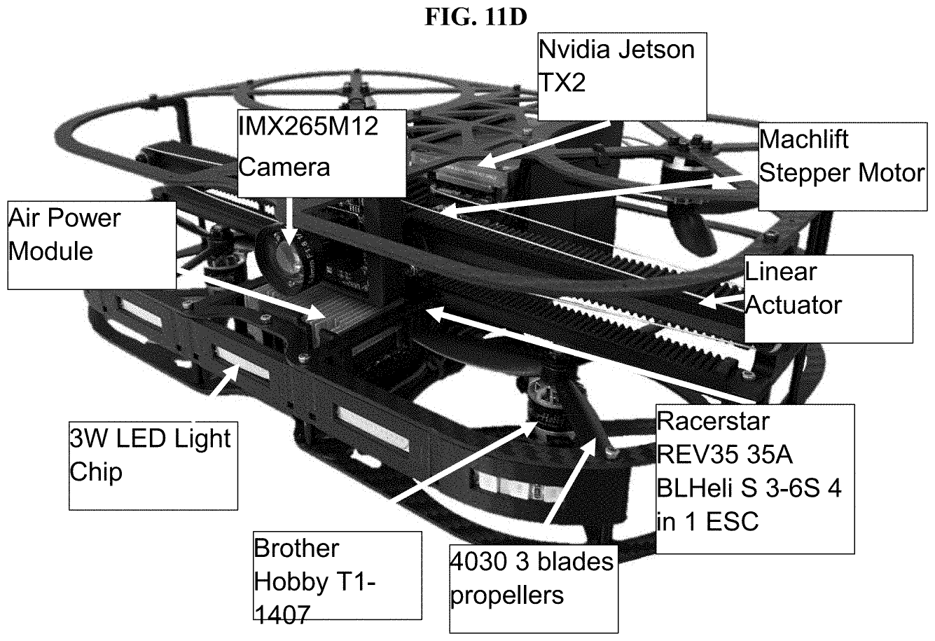

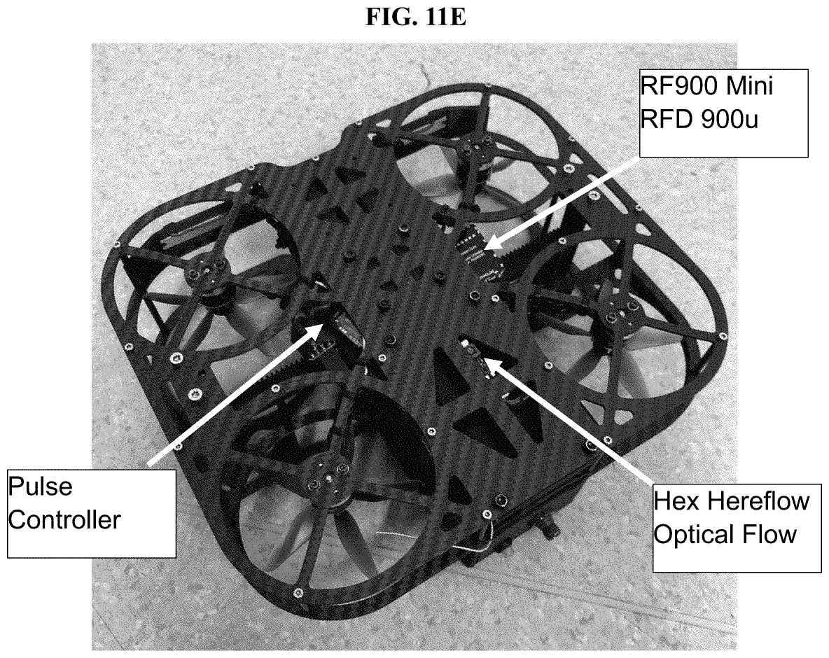

FIG. 11A shows components of the pseudo-stereo camera assembly according to various embodiments. The components in the camera assembly may include (a) spur gear, (b) Machlift stepper motor, (c) DRV8334 stepper motor driver, (d) gear rack, (e) camera chasis, (f) IMX185 camera, (g) roller bearing, (h) pulley, and (i) fishing line.

The average efficient size of the area for an aerial robot to operate within the cavity may be 850 mm by 150 mm by 350 mm. The Bearing Inspector for Narrow-space Observation (BINO) vehicle BINO vehicle may stand at 231 mm by 76 mm by 200 m. Within its frame, the vehicle may have adequate space to install all necessary systems. The box-in design of BINO may ensure continuous safe operation even if it knocks into the wall of the cavity. The current size of BINO may allow a maximum permissible angle of 20° tilt within the cavity. FIG. 11B shows the components of the box-in frame design of the Bearing Inspector for Narrow-space Observation (BINO) vehicle according to various embodiments. FIG. 11C shows the Bearing Inspector for Narrow-space Observation (BINO) vehicle with power tethering unit according to various embodiments. The vehicle may include (j) carbon fiber frame, (k) companion computer (Nvidia Jetson TX2), (1) the linear actuator camera assembly corresponding to FIG. 11A, (m) flight controller (Pixracer), (n) power system, i.e. DC-DC voltage converter (auxiliary connector Racestar 50A ESC), (o) propulsion system (Brother Hobby T1-1407 4-inch Propeller), (p) illumination (LED light chip), and (q) tethering unit. FIG. 11D shows a side view of the Bearing Inspector for Narrow-space Observation (BINO) vehicle according to various embodiments. FIG. 11E shows a top view of the Bearing Inspector for Narrow-space Observation (BINO) vehicle according to various embodiments.

The companion computer/processor (Nvidia Jetson TX2) and/or the flight controller (Cube Black, Cube Purple, PixRacer) may be coded with Python and/or C++, and may include open source code, e.g. Tensorflow, Keras, PyTorch, PX4, APM, UNet, PointNet etc.

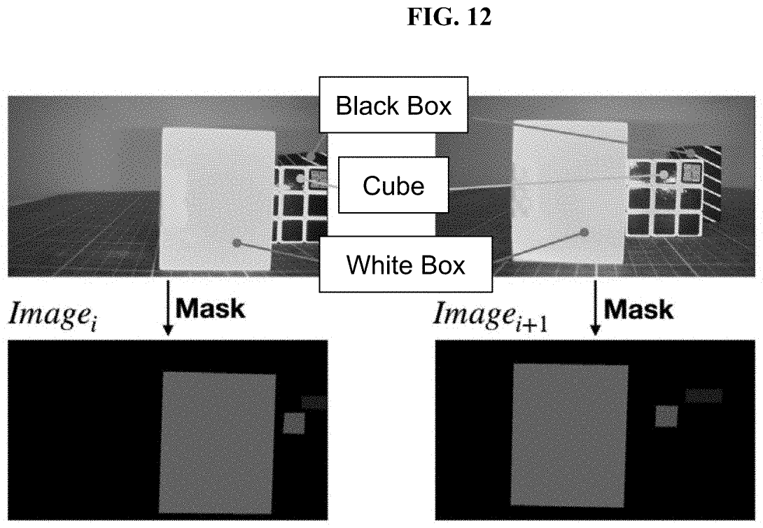

The depth calculated through the algorithm as described herein may be compared with the actual depths for three different objects. FIG. 12 shows the depth calculation of using disparity values between generated masks from image pair according to various embodiments.

The camera assembly may take ten to twenty images along different positions on the actuator. Next, the targeted region may be annotated and the masks of the objects may be generated. With these masks, the disparity values may be calculated (using Equation 11), thereby allowing for the derivation of depth (using Equation 2). Table V compares the calculated depths with the actual depths of different objects.

TABLE V

| White Box Depth (mm) | | | Cube Depth (mm) | | | Black Box Depth (mm) | | |
|---|---|---|---|---|---|---|---|---|
| Calculated | Actual | Error | Calculated | Actual | Error | Calculated | Actual | Error |
| 136.38 | 156.45 | 20.07 | 185.95 | 206.45 | 20.50 | 232.86 | 256.45 | 23.59 |
| 136.46 | 156.45 | 20.00 | 233.43 | 256.45 | 23.02 | 185.01 | 206.45 | 21.44 |
| 187.63 | 206.45 | 18.82 | 138.50 | 156.45 | 17.95 | 234.74 | 256.45 | 21.71 |
| 188.21 | 206.45 | 18.24 | 234.43 | 256.45 | 22.02 | 138.04 | 156.45 | 18.41 |
| 236.41 | 256.45 | 20.04 | 137.92 | 156.45 | 19.53 | 186.04 | 206.45 | 20.41 |
| 235.21 | 256.45 | 21.24 | 186.01 | 206.45 | 20.44 | 134.59 | 156.45 | 21.86 |

| | | | | | |
|---|---|---|---|---|---|
| Avg Error at | 19.24 | Avg Error at | 19.97 | Avg Error at | 21.94 |
| 156.45 nm | | 206.45 nm | | 256.45 nm | |

The expected operating depth range of BINO is between 150 mm to 250 mm. Within this range, the difference between the depth errors of different depths may be marginal, and hence may be treated as an average error of 20.35 mm as offset, to be added to Equation 2. The existence of this error may come from focal length errors from the calibration process and the very slight inconsistency of the baseline distance of the actuator due to no micro-stepping of the motor.

Table VI shows the effect of measurements without either depth information or any reference object on the accuracy of X₁, A₁, X₂ and A₂. RSME refers to the root-mean square deviation while max refers to the maximum value.

TABLE VI

| X₁ (mm) | | A₁ (mm) | | X₂ (mm) | | A₂ (mm) | |
|---|---|---|---|---|---|---|---|
| RMSE | max | RMSE | max | RMSE | max | RMSE | max |

Without Reference Object

| | | | | | | | |
|---|---|---|---|---|---|---|---|
| 2.08 | 2.55 | 4.22 | 3.42 | 0.8 | 1.48 | 2.44 | 2.78 |

Without Depth Information

| | | | | | | | |
|---|---|---|---|---|---|---|---|
| 2.30 | 4.37 | 3.33 | 3.88 | 8.04 | 9.32 | 3.25 | 4.85 |

The results (see Table VI) show that without either information, the overall accuracy of the measurements decreases in most aspects. This decrease in the case of no reference may be due to unreliable focal length (pixel coordinate) of the stitched image, and in the case of no depth information is due to all of the targeted region is not on the same planar as the reference region. Measurements without reference may be calculated using Equations 12 and 13, while measurement without depth may be calculated using a modified Equation 14, removing the depth component, D_{ref} and D_{1,2}.

In order to further validate the performance of the algorithm with the newly added offset, it may be compared to measurements, X₁, A₁, X₂ and A₂, obtained from a popular commercial depth camera (Intel Realsense 435i). A minimum of 300 mm depth were required before any reasonable measurements was able to be taken from the Realsense. However, even at 300 mm, the measurement X_{1,2} was not obtainable due to poor depth map quality, especially at both ends of the bearing.

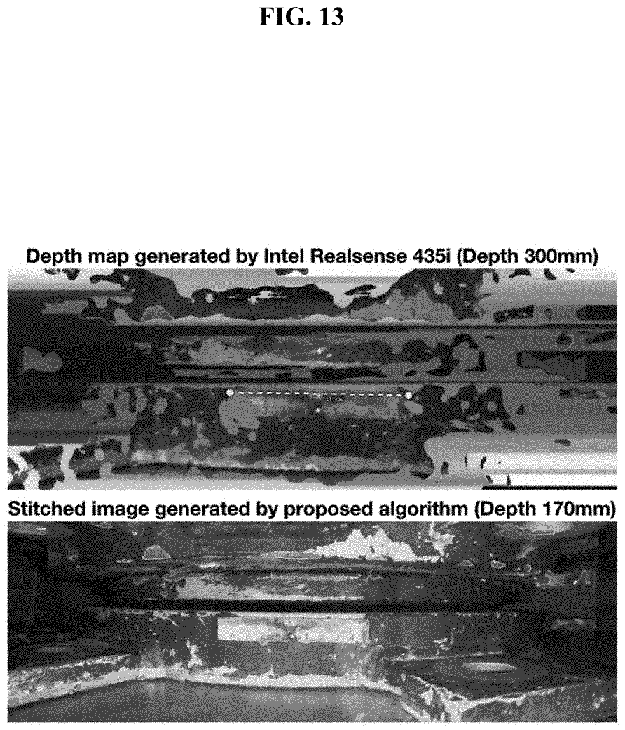

FIG. 13 shows (above) a depth map generated by a commercial depth camera (Intel Realsense 435i); and (below) a stitched image formed by the algorithm (depth 170 mm) according to various embodiments.

Using the proposed algorithm and Equation 12, the calculation of Ref resulted in 109.32 mm at a depth of 170 mm. The rest of the measurements, X₁, A₁, X₂ and A₂, obtained using the algorithm at various depths is shown in Table VIII. Table VIII shows the Intel Realsense 435i measurements obtained at a depth of 300 nm.

TABLE VIII

| X₁ (mm) | A₁ (mm) | X₂ (mm) | A₂ (mm) | Ref (mm) |
|---|---|---|---|---|
| — | 10 mm | — | 10 m | 110 |

The depth camera is hence, proven not to be a viable solution for this application as the depth map generated by the Realsense is not of sufficient quality to obtain the required measurements, even at 300 mm of depth.

A series of experiments were conducted. The experiments include runs of the complete operation of BINO together with the proposed algorithm to obtain measurements X₁, A₁, X₂ and A₂. The obtained measurements are then compared to the ground truth measurements to determine the accuracy of the proposed algorithm. All experimental runs were conducted on our rail viaduct cavity mock-up. Installing the cavity mock-up allows for the increase the cavity entrance height to its highest point. Furthermore, all dimensions of the cavity are according to the actual cavity. The cavity it houses an actual decommissioned rail viaduct bearing.

Manual extraction of the ground truth measurements is possible by lowering the mock-up. For the ten experimental runs, the BINO vehicle was manually flown into the cavity. For each flight, we tried to ensure that the BINO vehicle lands in parallel to the rail viaduct bearing at a minimum depth of 150 mm (from camera to reference object). The proposed algorithm calculated the dimensions of the target region in a single sequence. Tabulation of the dimensions obtained from the proposed algorithm is described in Table VIII. The mean and standard deviation (STD) of the results provide an initial insight into the measurement quality obtained from the algorithm. The accuracy of the algorithm, in the form of root mean squared error (RMSE) and max error, is also calculated. The average RMSE of ten experimental runs is 1.23 mm while the average max error is 2.23 mm.

Table VIII shows the experimental results.

TABLE VIII
Rail Viaduct Bearing Ground Truth Measurement

| X₁ (mm) | A₁ (mm) | X₂ (mm) | A₂ (mm) |
|---|---|---|---|
| 18.75 | 8.65 | 6.13 | 8.73 |

Experimental Result Description

| X₁ (mm) | | A₁ (mm) | | X₂ (mm) | | A₂ (mm) | |
|---|---|---|---|---|---|---|---|
| Mean | STD | Mean | STD | Mean | STD | Mean | STD |
| 19.22 | 1.27 | 9.01 | 0.96 | 6.67 | 11.46 | 8.21 | 1.11 |

Experimental Errors

| X₁ (mm) | | A₁ (mm) | | X₂ (mm) | | A₂ (mm) | |
|---|---|---|---|---|---|---|---|
| RMSE | max | RMSE | max | RMSE | max | RMSE | max |
| 1.29 | 2.23 | 0.98 | 2.00 | 1.48 | 1.78 | 1.17 | 1.93 |

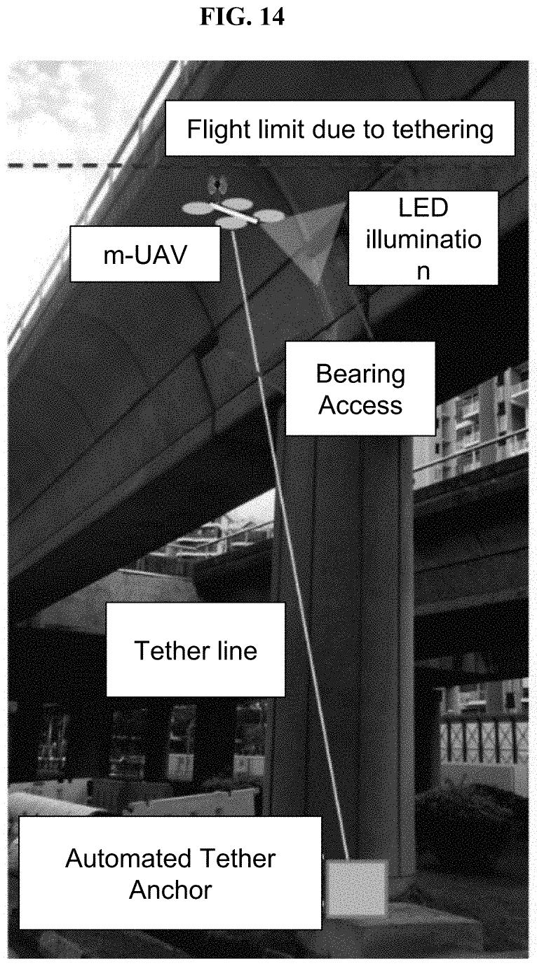

FIG. 14 is an image illustrating a power tethering unit coupled to the aerial vehicle (micro unmanned aerial vehicle or mUAV) according to various embodiments. The power tethering unit may be a smart tether system.

The power tethering unit may include an automated tether anchor and a tether line having a first end physically coupled to the automated tether anchor, and a second end physically coupled to the frame of the aerial vehicle.

The smart tether system may provide 3 functions: (1) Ensure safe operation of the aerial vehicle and physically limit the flight altitude of the aerial vehicle so that it cannot interfere with above viaduct rail operations; (2) provide an anchor so that the aerial vehicle is easier to operate, and (3) establish a power link between with the aerial vehicle so that the vehicle may be powered from the ground, thereby allowing the vehicle to operate for an extended period of time. The smart tether system may be automated and may automatically regulate the tether line so that the tether line is taut and would not slack during operation. The system may be designed such that the tethering unit may be removed for free flight inspection as and when required and allowed by authorities.

Various embodiments may be employed for construction site inspection, aerospace inspection, transportation infrastructure inspection, façade inspection, and/or urban infrastructure inspection.

By “comprising” it is meant including, but not limited to, whatever follows the word “comprising”. Thus, use of the term “comprising” indicates that the listed elements are required or mandatory, but that other elements are optional and may or may not be present.

By “consisting of” is meant including, and limited to, whatever follows the phrase “consisting of”. Thus, the phrase “consisting of” indicates that the listed elements are required or mandatory, and that no other elements may be present.

The inventions illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

By “about” in relation to a given numerical value, such as for temperature and period of time, it is meant to include numerical values within 10% of the specified value.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims and non-limiting examples. In addition, where features or aspects of the invention are described in terms of Markush groups, those skilled in the art will recognize that the invention is also thereby described in terms of any individual member or subgroup of members of the Markush group.

1. An aerial vehicle comprising:
a frame;
a camera assembly attached to the frame, the camera assembly comprising a cascaded bi-directional linear actuator and a camera attached to the cascaded bi-directional linear actuator such that the camera is configured to be moved to different positions by the cascaded bi-directional linear actuator to capture a plurality of images of an object;
a processor in electrical connection to the camera such that the processor is configured to determine one or more dimensions of the object based on the plurality of images;
a flight system configured to move the aerial vehicle; and
an energy system in electrical connection to the camera assembly, the processor, and the flight system.

2. The aerial vehicle according to claim 1,
wherein the processor is configured to determine a depth between the camera and a reference region of the object.

3. The aerial vehicle according to claim 2,
wherein the processor is further configured to determine a distance between adjacent positions of the camera to capture successive images of the plurality of images based on the depth between the camera and a reference region of the object, and a desired overlap percentage between the successive images.

4. The aerial vehicle according to claim 2,
wherein the processor is configured to stitch the plurality of images to form a stitched image.

5. The aerial vehicle according to claim 4,
wherein the processor is configured to determine one or more targeted regions in the stitched image using an image semantic segmentation neural network.

6. The aerial vehicle according to claim 5,
wherein the processor is configured to determine a depth between the camera and each targeted region of the one or more targeted regions based on images of the plurality of images capturing the one or more targeted regions.

7. The aerial vehicle according to claim 6,
wherein the processor is configured to determine one or more dimensions of the object in the stitched image;
wherein the processor is configured to determine one or more dimensions of the reference region in the stitched image; and
wherein the one or more dimensions of the object are determined based on the depth between the camera and each targeted region of the one or more targeted regions, the one or more dimensions of the object in the stitched image; the one or more dimensions of the reference region in the stitched image, one or more dimensions of the reference region in the object; and the depth between the camera and the reference region.

8. The aerial vehicle according to claim 1, wherein the flight system comprises a propulsion system configured to propel the aerial vehicle, and a flight controller configured to control the propulsion system to move in a desired direction.

9. The aerial vehicle according to claim 1, further comprising:
an illumination system configured to provide illumination to the object.

10. The aerial vehicle according to claim 1, wherein the energy system comprises a power system configured to be electrically coupled to a power tethering unit.

11. The aerial vehicle according to claim 1,
wherein the cascaded bi-directional linear actuator comprises a motor; and
wherein the cascaded bi-directional linear actuator further comprises a rack-and-pinion system configured to move the camera linearly based on a rotational motion of the motor.

12. A method of forming an aerial vehicle, the method comprising:
attaching a camera assembly to a frame, the camera assembly comprising a cascaded bi-directional linear actuator and a camera attached to the cascaded bi-directional linear actuator such that the camera is configured to be moved to different positions by the cascaded bi-directional linear actuator to capture a plurality of images of an object;
electrically connecting a processor to the camera such that the processor is configured to determine one or more dimensions of the object based on the plurality of images;
providing a flight system configured to move the aerial vehicle; and
electrically connecting an energy system to the camera assembly, the processor, and the flight system.

13. The method according to claim 12,
wherein the processor is configured to determine a depth between the camera and a reference region of the object.

14. The method according to claim 13,
wherein the processor is further configured to determine a distance between adjacent positions of the camera to capture successive images of the plurality of images based on the depth between the camera and a reference region of the object, and a desired overlap percentage between the successive images.

15. The method according to claim 13,
wherein the processor is configured to stitch the plurality of images to form a stitched image.

16. The method according to claim 15,
wherein the processor is configured to determine one or more targeted regions in the stitched image using an image semantic segmentation neural network.

17. The method according to claim 16,
wherein the processor is configured to determine a depth between the camera and each targeted region of the one or more targeted regions based on images of the plurality of images capturing the one or more targeted regions.

18. (canceled)

19. (canceled)

20. The method according to claim 12, further comprising:
providing an illumination system to provide illumination to the object.

21. (canceled)

22. (canceled)

23. A method of determining one or more dimensions of an object, the method comprising:
moving an aerial vehicle towards the object using the using a flight system of the aerial vehicle, the aerial vehicle also comprising:
a frame;
a camera assembly attached to the frame, the camera assembly comprising a cascaded bi-directional linear actuator and a camera attached to the cascaded bi-directional linear actuator;
a processor in electrical connection to the camera; and
an energy system in electrical connection to the camera assembly, the processor, and the flight system; and
moving the camera to different positions using the cascaded bi-directional linear actuator to capture a plurality of images of the object; and
determining one or more dimensions of the object based on the plurality of images using the processor.

24. The method according to claim 23,
wherein the object is a rail viaduct bearing, and
wherein the rail viaduct bearing is within a cavity formed by a rail viaduct and a structural pier.

25. (canceled)
